(19) United States
(12) Patent Application Publication
(10) Pub. No.: US 2016/0078547 A1
(43) Pub. Date: Mar. 17, 2016

(54) METHODS AND SYSTEMS FOR CALCULATION OF INSURANCE RELATED FEES FOR AN INSURANCE PRODUCT

(71) Applicant: eBaoTech Corporation, Shanghai (CN)

(72) Inventor: Henry HE, Shanghai (CN)

(73) Assignee: eBaoTech Corporation, Shanghai (CN)

(21) Appl. No.: 14/639,951

(22) Filed: Mar. 5, 2015

(30) Foreign Application Priority Data
Sep. 12, 2014 (CN) 201410461570.0

(51) Int. Cl. G06Q 40/08

(52) U.S. Cl. CPC G06Q 40/08

(57) ABSTRACT

A method for adjustment in calculation of insurance related fees for an insurance product is disclosed, comprising (a) determining type and sequence of adjustments; (b) applying one or more adjustments to an initial value obtained by a predetermined function; and (c) serving an adjusted value so obtained as basis for subsequent calculation. A method for calculation of insurance related fees is disclosed comprising a step of rebalancing.

### CROSS-REFERENCE TO RELATED APPLICATION

The present invention claims priority from Chinese Patent Application No. 201410461570.0, filed on Sep. 12, 2014, and titled “methods and systems for calculation of insurance related fees for an insurance product,” the entire disclosure of which is incorporated herein by reference.

### TECHNICAL FIELD

The instant invention relates to methods and systems for calculation of insurance related fees and, in particular, to methods and systems for calculation and adjustment insurance related fees such as premiums and premium-derivated fees.

### BACKGROUND

The calculation of insurance related fees for a insurance product is very complicated due to the variation of for example numbers and types of coverage, insured object, and other factors. The calculation process is therefore normally carried out by computer software. However, insurance products change in terms of coverage, insured object, discount, tax and others. It causes that the insurance related fees always need to be recalculated even for two policies with exactly same policy clauses.

Conventionally, the process of calculation of premiums and derivatives is generally performed as follows. An initial value is calculated based on predetermined formula (functions) for each of coverage. The initial value is then subject to various types of adjustments in predetermined sequence and the adjusted values for each coverage so obtained are added to output the premium and its derivatives. The types of adjustments may include, for example, insurance term adjustment, various discounts, loading premium, minimum premium and etc. The order and types of the adjustments for those methods are pre-defined without possibility to change. When it is necessary to change the order or type of any of the adjustments to meet market changes, however, the software code has to be rewritten and followed by software debugging to generate new software for the purpose of calculation. This not only makes the calculation process complicated but also contributes to inefficiency and less adaptability.

Moreover, the outputs of conventional methods are fees for a whole insurance policy. Those methods can not provide respective contribution of each insurance coverage or insured object to the whole insurance policy. It is therefore difficult for insurance practitioners, such as insurance companies or insurance software providers, to track market data and then to adjust insurance coverage or other content of a policy. This may cause damage or loss of market opportunity.

In view of the foregoing, there still exists a need for improved insurance related fees calculation to achieve optimized calculation so as to improve calculation efficiency and effect quick market response.

### SUMMARY

One aspect of the invention is to provide a computer-implemented method for adjustment in calculation of insurance related fees for an insurance product, the method comprising steps of

(a) determining type and sequence of adjustments;

(b) applying one or more adjustments to an initial value obtained by a predetermined function, according to the type and sequence of adjustments as determined in step (a); and

(c) serving an adjusted value so obtained in step (b) as basis for subsequent calculation.

Another aspect of the invention is to provide a computer-implemented method for calculation of insurance related fees for an insurance product, the insurance product comprising one or more insured objects, and each of the one or more insured objects involving one or more insurance coverage, the method comprising steps of

(a) evaluating for each of the insurance coverage of each of the insured objects, according to a predetermined function, to obtain an initial value for each of the one or more insurance coverage;

(b) applying at least one type of adjustments to the initial value for each of the one or more insurance coverage, to obtain an adjusted value for each of the one or more insurance coverage;

(c) summing, for each of the one or more insured objects, the adjusted values for the one or more insurance coverage involved, to obtain an initial value for each of the one or more insured objects;

(d) applying at least one type of adjustments to the initial value for each of the one or more insured objects, to obtain an adjusted value for each of the one or more insured objects;

(e) summing the adjusted values for the one or more insured objects, to obtain an initial value of premium for the insurance product, and applying at least one type of adjustments to the initial value of premium to obtain an adjusted value of premium;

(f) rebalancing in proportion the adjusted value of premium to each of the one or more insured objects, so that each of the one or more insured objects having a corresponding rebalanced value;

(g) rebalancing in proportion the corresponding rebalanced value for each of the one or more insured objects to each of the one or more insurance coverage of a corresponding insured object, so that each of the one or more insurance coverage having a corresponding rebalanced value; and

(h) serving the corresponding rebalanced value for each of the one or more insurance coverage as an initial value for corresponding insurance coverage in next calculation.

Yet another aspect of the invention provides a computer-implemented method for calculation of insurance related fees for an insurance product, the insurance product comprising one or more insured objects, and each of the one or more insured objects involving one or more insurance coverage, the calculation being performed in two or more than two stages, and in a first stage, the method comprising steps of

(a) evaluating for each of the insurance coverage of each of the insured objects, according to a predetermined function, to obtain an initial value for each of the one or more insurance coverage;

(b) applying at least one type of adjustments to the initial value for each of the one or more insurance coverage, to obtain an adjusted value for each of the one or more insurance coverage;

(c) summing, for each of the one or more insured objects, the adjusted values for the one or more insurance coverage involved, to obtain an initial value for each of the one or more insured objects;

(d) applying at least one type of adjustments to the initial value for each of the one or more insured objects, to obtain an adjusted value for each of the one or more insured objects;

(e) summing the adjusted values for the one or more insured objects, to obtain an initial value of premium for the insurance product, and applying at least one type of adjustments to the initial value of premium to obtain an adjusted value of premium;

(f) rebalancing in proportion the adjusted value of premium to each of the one or more insured objects, so that each of the one or more insured objects having a corresponding rebalanced value;

(g) rebalancing in proportion the corresponding rebalanced value for each of the one or more insured objects to each of the one or more insurance coverage of a corresponding insured object, so that each of the one or more insurance coverage having a corresponding rebalanced value;

(h) serving the corresponding rebalanced value for each of the one or more insurance coverage as an initial value for corresponding insurance coverage in next stage of calculation; and

(i) repeating steps (b) to (h) to perform a second and further stages of calculation until all predetermined types of adjustments being applied, wherein one or more adjustments of a different type is applied in each stage, and adjusted values obtained from the last adjustments are served as insurance related fees for the insurance product.

Other aspects of the invention relate to computer systems performing the methods described herein. The system comprises a storage device, and at least one processor configured to perform said method.

Further aspects of the invention relate to non-transitory computer-readable medium having instructions stored thereon, the instructions, when executed by at least one processor, performing one of the methods described herein.

The methods and systems provided herein are highly configurable, i.e., when one or more adjustments need to be incorporated to an insurance product due to such as market changes, the insurance related fees can easily be recalculated by addition, deletion or modification of corresponding adjustment types and/or change of the sequences of those adjustments, without the need of software code rewritten and debugging. The calculation methods and systems described herein are thus simple, fast, and well-adaptable to market changes.

Furthermore, by rebalancing steps, each of the insurance coverage and insured objects can have a rebalanced value and its contribution to the whole insurance policy can be calculated, which facilitates market data tracking and statistic analysis. The insurance coverage or other policy clauses can be adjusted in a timely manner to meet market needs.

### BRIEF DESCRIPTION OF DRAWINGS

FIG. 1 is a flow chart of an exemplary method for adjustment according to one embodiment of the invention.

FIG. 2 is a schematic view of an exemplary method for adjustment when a plurality of adjustment steps is involved.

FIG. 3 is a schematic view of an adjustment method involving a pre-apply criteria and a post-apply criteria before and after an adjustment step respectively.

FIG. 4 is a schematic view of an adjustment method involving a final validation step.

FIG. 5 shows a flowchart of re-calculation when the final validation is failed.

FIG. 6 schematically shows a computing system for carrying out the methods of the invention.

FIG. 7 shows an embodiment of the calculation method according to the present invention.

FIG. 8 shows a calculation method when a plurality of adjustment steps is involved.

FIG. 9 shows a calculation method involving a pre-apply criteria and a post-apply criteria before and after an adjustment step respectively.

FIG. 10 is a schematic view of a calculation method involving a final validation step.

FIG. 11 shows a flowchart of re-calculation when the final validation is failed.

FIG. 12 shows another embodiment of the calculation method according to the present invention.

### DETAILED DESCRIPTION OF THE INVENTION

The present invention will now be described in more detail with reference to specific examples and accompanied drawings. It should be understood that the examples provided herein are for descriptive purpose and shall not be constructed as limitation to the scope of the invention.

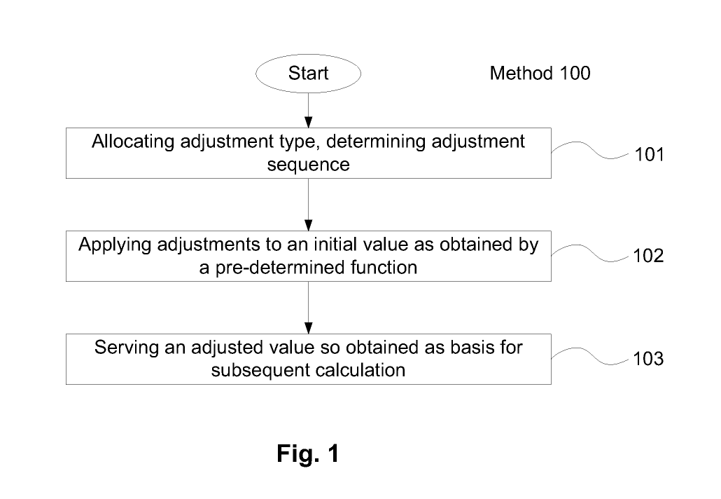

FIG. 1 show a flow chart of a method 100 for adjustment used in the process of insurance related fees calculation for an insurance product. The method 100 comprises steps of determining type and sequence of adjustments (step 101); applying one or more adjustments to an initial value obtained by a predetermined function, according to the type and sequence of adjustments as determined in step 101 (step 102); and serving an adjusted value so obtained in step (102) as basis for subsequent calculation (step 103).

In step 101, the term “determining” means a process of selection or allocation. For example, one or more types of adjustment can be selected for use from a list of types of adjustment currently available. Alternatively, a new type of adjustment may be added. Further examples include one or more types of adjustment or factors thereof may be modified, and one or more types of adjustment can be deleted from the list currently available.

The process of “determining” also includes a step of allocating each of the types of adjustment to a suitable subject to be adjusted. For example, one or more types of adjustment may be allocated to insurance coverage, or one or more types of adjustment, same with or different than those allocated to insurance coverage, may be allocated to insured object, and/or one or more types of adjustment, same with or different than those described above, may be allocated to insurance policy, such that the types of adjustments determined are applied at levels of insurance coverage, insured object and/or insurance policy.

The types of adjustments may include types currently available including, but not limited to, minimum premium, period of insurance (POI), discounts, loading, underwriting, campaign, tax, fee, commission, assignment and null.

The term “minimum premium” adjustment, as used herein, means a process of adjusting an initial value to a value corresponding to the minimum premium, when the initial value is less than the requirement of the minimum premium. For example, the “minimum premium” adjustment may be used for the adjustments for insurance coverage or insurance policy. Specifically, for example, when an initial value for an insurance coverage is calculated, according to a predetermined function, less than that as required by the minimum premium, the initial value so calculated will be adjusted to the value corresponding to the minimum premium.

The term “POI” adjustment as used herein is meant to increase or decrease an initial value in proportion according to the period of insurance as agreed in the insurance policy. For example, if the calculation result of a predetermined function is an initial value corresponding to one year POI, and when the POI is set to a period of 2 years or 6 months, the initial value will be multiplied or divided by 2 to obtain an adjusted value. In some embodiments, the “POI” adjustment may not increase or decrease a value in proportion, for example may be performed by rules set by users. The POI adjustment is, for example, applicable at level of insurance coverage.

The term “discount” adjustment, as used herein, is a process of decreasing an initial value by fixed amount or percentage. The values for fixed amounts and percentages can be increased or decreased as required, in order to meet market demands. “Discount” adjustment can be used at level of insurance coverage and/or insurance policy.

The term “loading” adjustment as used herein is meant to increase an initial value when certain circumstances occur. For example, when a specific condition is met by an insured object, an initial value is adjusted to a higher value. For example, if an insured object is more than 50 years old, the initial value for an insurance coverage as calculated according to a predetermined function is increased by 10%. The “loading” adjustment is applicable at level of insurance coverage and/or insurance policy.

The term “underwriting” adjustment as used herein means a process of manual adjustment to an initial value by an underwriter. The underwriter may be a representative of an insurance company, such as an employee or an agent. The “underwriting” adjustment can occur in the level of insurance coverage, insured object or insurance policy.

The term “campaign” adjustment as used herein means certain adjustment to insurance related fees by insurance company during certain period or stage for purpose of promotion or others. This type of adjustment is performed based on specific needs of an insurance company and may be applied to various factors of insurance coverage, insured object or insurance policy. Typically, the “campaign” adjustment can be used at level of insurance coverage and/or insurance policy.

As used herein, the term “tax” adjustment is a process of taxation to an initial value. Generally, the “tax” adjustment varies from country to country as tax policies vary. The “tax” adjustment is typically used at level of insurance policy.

The terms “fee” adjustment and “commission” adjustment, as used herein, is a process of cost deduction from an initial value of a premium for an insurance policy. The “fee” adjustment is used for deducting fees occur during or after the generation of an insurance policy, and the “commission” adjustment is used for deducting commission of an agent or other representatives from an premium. These adjustments are typically applicable at level of insurance policy.

The term “assignment” adjustment as used herein means a process of serving an initial value directly as an adjusted value. Generally, when a certain subject needs not to be adjusted or no adjustment is available for that subject, the initial value is directly used as an adjusted value for subsequent calculation. This can occur at various levels of insurance related fees calculation, including insurance coverage, insured object and insurance policy.

The term “insurance related fees” as used herein is meant to include a premium for an insurance policy and various insurance derivative fees originated from the premium. The “premium for an insurance policy” is a total amount of a premium as calculated for an insurance policy, which may be net premium or gross premium. The “insurance derivative fees” may include for example commissions, actual contribution of an insurance coverage to premium, actual contribution of an insured object to premium, and etc.

Upon determination of the types of adjustment to be applied, the method 100 starts to sequence those types of adjustment, so as to determine the sequence in which the types of adjustment are applied. The sequence can be set as desired by an insurance company or an insurance software designer. The sequence can be set according to the type of an adjustment. For example, at level of insurance coverage, a POI adjustment may be prior to a loading adjustment, and a minimum premium adjustment may be the final adjustment. As a further example, at level of insurance policy, a minimum premium adjustment may be prior to tax and fee adjustments, and the fee adjustment may be prior to a commission adjustment.

In other embodiment, the sequence can also be determined according to adjustment factors (such as percentages or fixed amount, as will be described here below in detail) or priority as set by users.

In step 102, an “initial value” is an initial result as calculated by a predetermined mathematical function. A predetermined function is generally a function established by an insurance company or an insurance software provider based on empirical approach or statistical data, with a plurality of insurance factors involved. Insurance factors may include risk, indemnity, damage and etc. Those functions are well known and presented in different forms. For example, a function relating to insurance coverage of vehicle collision may be involved with factors such as normal driving area, main driver driving experience, age of main driver and etc. In addition, a predetermined function can also simply be a Sum function. For example, for a certain insured object, an initial value can be calculated by a Sum function through the aggregation of adjusted values for insurance coverage of the insured object. As a further example, for a certain insurance policy, an initial value can be obtained by a Sum function through the aggregation of adjusted values for insured objects of the policy.

In the present invention, the adjustments of step 102 may be completed in one or more stages and typically in two or more than two stages. When all the adjustments are to be performed in only one stage, the adjustments are performed one by one in sequence as previously determined. When the adjustments are to be completed in two or more than two stages, one or more adjustments are applied in a first stage, and one or more adjustments which are different from those applied in the first stage are applied in a second and further stages until all the types of adjustments as previously determined are applied.

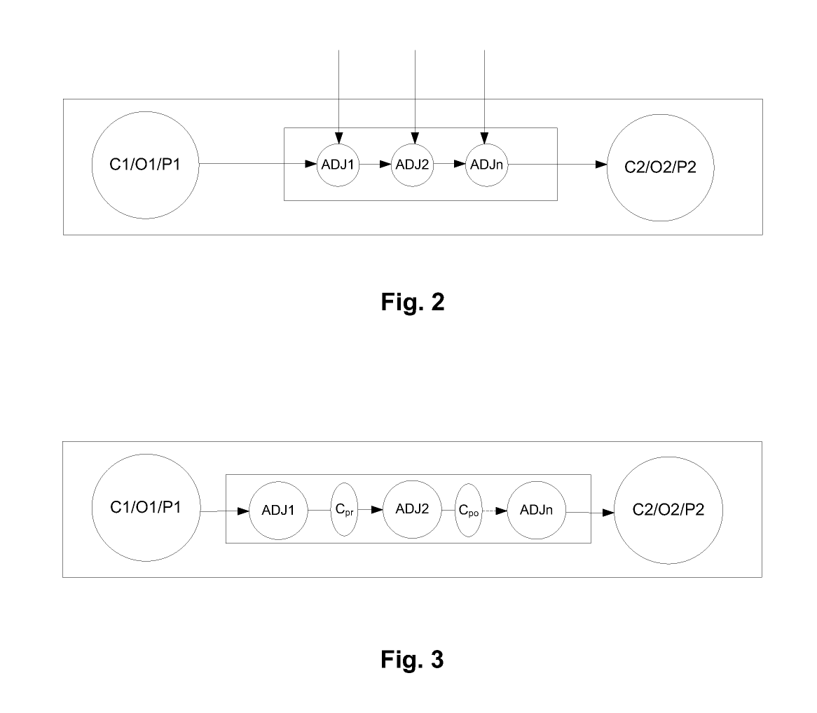

As shown in FIG. 2, following initial value calculations by predetermined functions, the insurance coverage has an initial value C1, or the insured object has an initial value O1, or the policy has an initial value P1. One, two or n (n is an integer greater than 2) adjustments ADJ1, ADJ2 or ADJn are applied to the initial values, and the value obtained after ADJn is served as an adjusted value for subsequent calculation (i.e., coverage adjusted value C2, or insured object adjusted value O2, or policy adjusted value P2).

In step 103, the “adjusted value” is a value generated after adjustment(s) is applied to the initial value. When the initial value is subject to two or more than two adjustments, two or more than two adjusted values are formed. However, only the adjusted value obtained after the final adjustment is served as the basis for subsequent calculation, for example as a variable for a Sum function. The adjusted value may be greater than, less than or equal to the value immediately before the adjustment.

In the present invention, one or more adjustment factors may be present for each type of adjustment, including, but not limited to, fixed amount, percentage, maximum value, minimum value, and etc. The term “fixed amount” as used herein refers to fixed value which is variable with respect to types of adjustment. For example, the fixed value may be value A for loading adjustment and value B for discount adjustment. The fixed value may be a positive or negative value. It can also be pre-set and vary as desired. The term “percentage” as used herein refers to a proportion of an adjusted value ranged from 0 to 100% or more, for example, 150%, 200%, 300% or more. It is also pre-settable and can vary as desired. A “maximum value” and a “minimum value” mean that the adjusted value is not greater than and not less than a specific value, respectively. The specific value is pre-settable and can vary as desired. Similarly, the “percentage”, “maximum value” and “minimum value” are variable with respect to types of adjustment, so that a plurality of percentages, fixed amounts, maximum values, and minimum values, which are different from each other, may exist.

FIG. 3 shows an adjustment method according to one embodiment of the invention. In the embodiment as shown, a pre-apply criteria for an adjustment can be applied immediately before that adjustment. In one example, the method continues only when the pre-apply criteria is satisfied. For example, a pre-apply criteria Cpr is applied before the second adjustment AJD2 is applied, in order to determine whether the ADJ2 may be performed. Similarly, a pre-apply criteria Cpr is applied before the first adjustment AJD1 is applied, in order to determine whether the ADJ1 may be performed. Although only one pre-apply criteria is shown in the figure, a person skilled in the art will appreciate that the number of the pre-apply criteria can be more than one, and only when all the criteria are satisfied, the method can continue.

In the embodiment shown in FIG. 3, a post-apply criteria can be applied immediately after an adjustment. In one example, the method continues only when the post-apply criteria is satisfied. For example, a post-apply criteria Cpo is applied before the second adjustment AJD2 is applied, in order to determine whether the ADJ2 may be performed. Similarly, a post-apply criteria Cpo is applied before the first adjustment AJD1 is applied, in order to determine whether the ADJ1 may be performed. Although only one post-apply criteria is shown in the figure, a person skilled in the art will appreciate that the number of the post-apply criteria can be more than one, and only when all the criteria are satisfied, the method can continue.

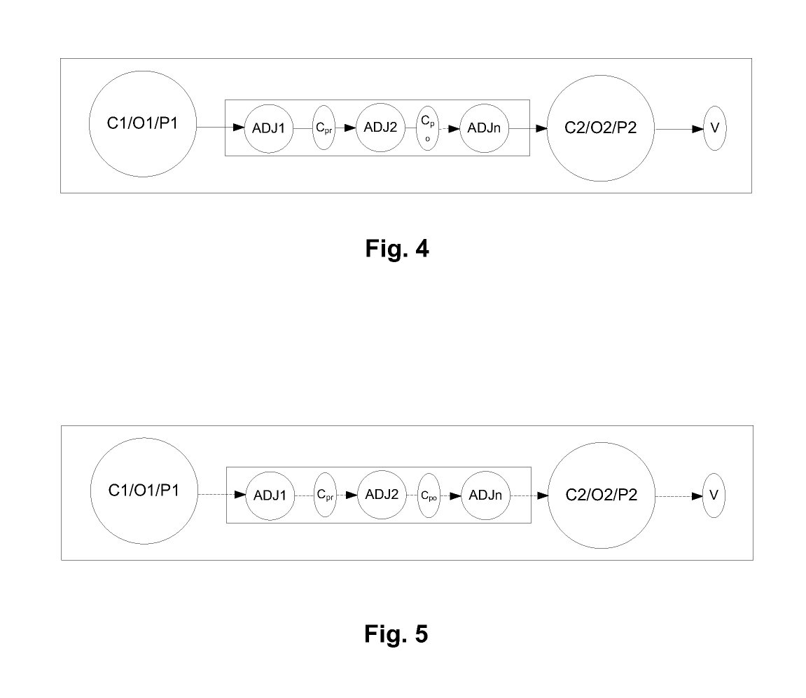

FIG. 4 shows an adjustment method according to another embodiment of the invention. In the method shown, a final validation step is performed following the last adjustment. For example, a final adjusted value is obtained after one or more adjustment, and a final validation step V is applied to the final adjusted value, in order to validate whether the final adjusted value satisfies any validation criteria as previously set. Although only one final validation step is shown in the figure, a person skilled in the art will appreciate that the number of the final validation step can be more than one, and only when all the steps are passed, the method can continue.

As shown in FIG. 5, in one embodiment where one of the final validation steps is failed, all previous calculation results are evicted and calculation is retried by for example resetting one or more adjustment factors. In one embodiment, when a max retry time limit is reached, for example, 10 times or less, the method is ended and an error is reported.

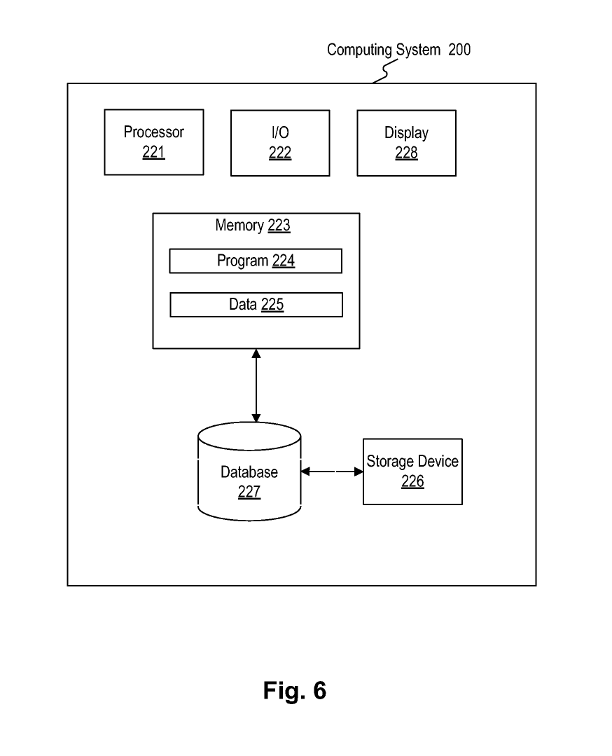

FIG. 6 illustrates a block diagram of a computing system 200 according to some disclosed embodiments. Computing system 200 may include a processor 221, an input/output (I/O) device 222, a memory 223, a storage device 226, a database 227, and a display device 228.

Processor 221 may be one or more known processing devices, such as a microprocessor. Processor 221 may include a single core or multiple core processor system that provides the ability to perform parallel processing. For example, processor 221 may be a single core processor that is configured with virtual processing technologies. In certain embodiments, processor 221 may use logical processors to simultaneously execute and control multiple processes. Processor 221 may implement virtual machine technologies, or other similar known technologies, to provide the ability to execute, control, run, manipulate, store, etc., multiple software processes, applications, programs, etc. In another embodiment, processor 221 includes a multiple-core processor arrangement (e.g., dual or quad core) that is configured to provide parallel processing functionalities to allow computing system 200 to execute multiple processes simultaneously. One of ordinary skill in the art would understand that other types of processor arrangements could be implemented that provide for the capabilities disclosed herein.

Memory 223 may include one or more storage devices configured to store instructions used by processor 221 to perform functions related to the disclosed embodiments. For example, memory 223 may be configured with one or more software instructions, such as program 224 that may perform one or more operations when executed by processor 221. The disclosed embodiments are not limited to separate programs or computers configured to perform dedicated tasks. For example, memory 223 may include a single program 224 that performs the functions of computing system 200, or program 224 could comprise multiple programs. Additionally, processor 221 may execute one or more programs located remotely from server 211.

Memory 223 may also store data 225 that may reflect any type of information in any format that insurance software provider 110 may use to perform functions consistent with the disclosed embodiments. For example, data 225 may include metadata of a plurality of functions associated with an insurance system, and other data enabling processor 221 to perform functions consistent with the disclosed embodiments.

I/O devices 222 may be configured to allow data to be received and/or transmitted by server 211. I/O devices 222 may include one or more digital and/or analog communication devices that allow computing system 200 to communicate with other machines and devices. Computing system 200 may also include or be communicatively connected to one or more of database 227 through network 140. In exemplary embodiments, database 227 may store metadata of adjustment factors to be used for insurance related fees calculation.

Another aspect of the invention provides a method for calculation of insurance related fees for an insurance product. Typically, an insurance product comprises one or more insured objects, and each of the insured objects may comprise one or more insurance coverage. For example, an insurance policy may include vehicle insurance and life insurance, and the insured object may be an automobile for the vehicle insurance and human body for the life insurance. For the vehicle insurance, the coverage may include collision insurance, theft and robbery insurance, a third party liability insurance and etc, and the coverage for life insurance may include accident insurance and critical illness insurance. More typically, one piece of policy may only include one insured object, and one insured object may include a plurality of insurance coverage.

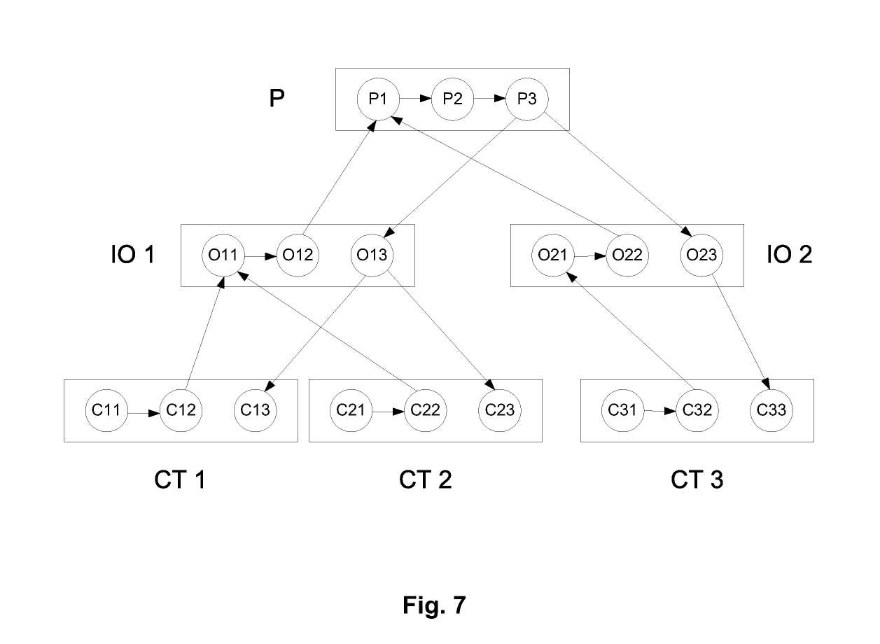

FIG. 7 schematically illustrates a calculation method for insurance related fees according to one embodiment of the invention. In the embodiment, the insurance product P comprises two insured objects IO1 and IO2. The insured object IO1 comprises coverage CT1 and CT2, and the insured object IO2 is consisted of coverage CT3. In this example, the calculation of insurance related fees for the insurance product P begins with the valuations of coverage CT1, CT2, CT3 for the insured objects based on pre-determined functions to obtain initial value C11, C21, C31 respectively for the coverage. As stated above, the pre-determined functions are normally established by an insurance company or an insurance software provider based on empirical approach or statistical data, with a plurality of insurance factors involved. Same coverage may have different pre-determined functions in different insurance companies.

Following the valuations of the initial values C11, C21, C31, the method applies at least one type of adjustment to the initial values C11, C21, C31 to obtain adjusted values C12, C22, C32 of coverage.

The at least one type of adjustment can be any one or more types of adjustment as described above. For example, the adjustment can be one or more selected from a group consisting of minimum premium, POI, discount, loading, underwriting, campaign, and assignment. For example, POI adjustment may be applied to C11, C21, C31 so that the initial value is adjusted to a value corresponding to a period of 3 years, 5 years, or longer.

The adjustments to each initial value of overage may be performed in parallel or in sequence. Preferably, the adjustments are performed in parallel. The adjustments may be completed in one or more stages, and if the adjustments are completed in more than one stage, the type of adjustment applied is different from stage to stage.

Following the adjustments described above, the adjusted values of each coverage for the insured objects IO1 and IO2, respectively, are aggregated to obtain an initial value for each of the insured objects. In this case, the initial value O11 for insured object IO1 is an aggregation of C12 and C22, and the initial value O21 for insured object IO2 is the value of C32.

Subsequently, for each of the initial values O11, O21 of the insured objects, at least one type of adjustment is applied, in order to obtain adjusted values O12 and O22 for the insured objects. In this step, the type of adjustment involved may be the same with, different from, partially same with, those applied at level of insurance coverage. For example, underwriting or assignment adjustment may be applied to each of the initial values of insured objects.

Then, the adjusted values O12 and O22 of the insured objects are aggregated to obtain an initial value P1 for the insurance product, followed by at least one type of adjustment to the initial value P1 to obtain an adjusted value P2. Similarly, the type of adjustment involved in this step may be the same with, different from, partially same with, those applied at level of insurance coverage/insured object. For example, the following types of adjustment may be applied to the initial value P1 of the insurance product: minimum premium, tax, fee, commission, underwriting or assignment.

Next, the adjusted value P2 is rebalanced in proportion to each of the insured objects IO1 and IO2 such that the latter will have a rebalanced value O13 and O23, respectively. In this step, the proportion stated above is determined on the basis of contribution ratio of the adjusted values O12 and O22 to the initial value P1 of the insurance product. For example, when O12 is 4 and O22 is 8, P1 is thus 12, and the adjusted value P2 may be 15 (for example subject to minimum premium adjustment), then O13 will be 5 (15*4/(4+8)), and O23 will be 10 (15*8/(4+8)). In this case, the rebalanced values are increased with respect to the adjusted values O12, O22.

In another example, the proportion may be determined based on the contribution ratio of the initial values O11 and O21 of insured objects to the initial value P1 of the insurance product. For example, when O11 is 4.2, O21 is 7.8, O12 is 4, and O22 is 8, P1 is thus 12 and adjusted value P2 may be 15, then O13 will be 5.25 (15*4.2/(4.2+7.8)), and O23 will be 9.75 (15*7.8/(4.2+7.8)). In this case, the rebalanced values are decreased with respect to the adjusted values O12, O22.

Similarly, each of the rebalanced values O13 and O23 is rebalanced further in proportion to each of the insurance coverage CT1, CT2, CT3 of the insured objects, such that each of the insurance coverage will have a corresponding rebalanced value C13, C23 and C33 and, the values C13, C23 and C33 will respectively be served as an initial value for respective coverage in subsequent calculation process. Typically, the adjusted value P2 will be served directly as a rebalanced value P3 for the insurance product. In some embodiments, however, the adjusted value P2 is subject to a post-apply validation and/or a final validation criteria before serving as the rebalanced value P3. In this step, the proportion is determined based on the contribution ration of each adjusted value of insurance coverage to the initial value of corresponding insured object. Take the example described above, when O11 is 4.2, O21 is 7.8, O13 is 5, and O23 is 10, C12 and C22 may be 2 and 2.2, respectively, and C32 may be 7.8, then C13 is 2.4 (5*2/4.2), C23 is 2.6 (5−2.4), and C33 is 10.

In some embodiments, a rebalanced value may be obtained by rounding-off, with accuracy settable as desired, for example, accurate to two decimal places. In some embodiments, the rebalanced values for the last insured object and last insurance coverage are obtained by rounding up. For example, the rebalanced value for the last insurance coverage of an insured object is obtained by subtracting rebalanced values for remaining insurance coverage of the insured object from the rebalanced value of the insured object.

Finally, insurance coverage has its rebalanced value, i.e., C13, C23 and C33, each insured object has its rebalanced value, i.e., O13 and O23, and the premium has its rebalanced value P3 which is equal to the adjusted value P2.

When further calculation is needed, the rebalanced values C13, C23 and C33 will be served as initial values C11, C21 and C31 for respective insurance coverage.

The method described above obtains actual contributed value of each coverage, which value is different from the calculation value (initial value) through calculation of pre-determined function, and the adjusted value of the calculation value. The actual contributed value reflects the actual contribution of each coverage to the premium of an insurance policy. The market data can therefore be tracked, in order to adjust coverage or other clauses of a policy in a timely manner to respond to market changes.

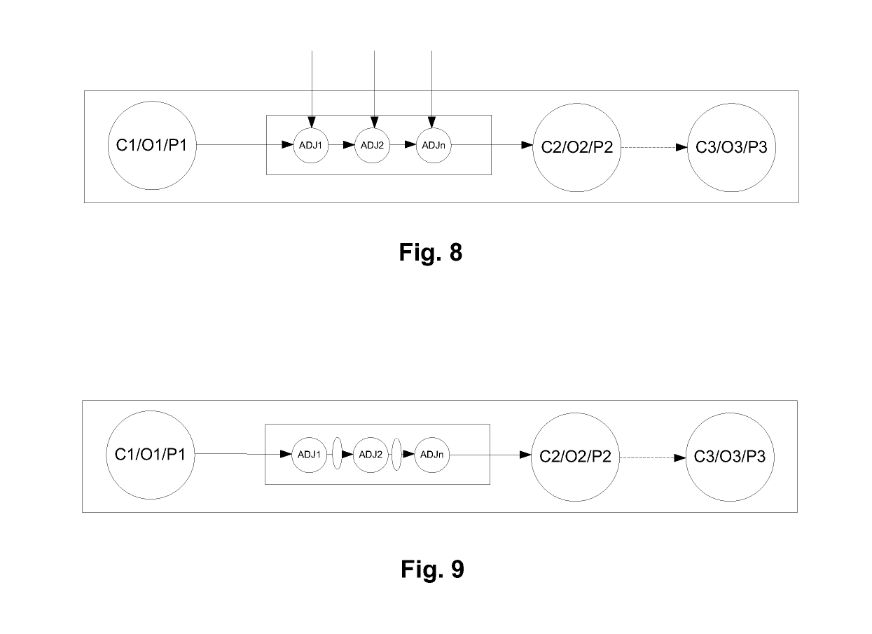

As described above with reference to adjustment methods, the adjustments can performed in succession and one or more pre-apply and/or post-apply criteria can be applied before and/or after one or more adjustments. FIGS. 8 and 9 show an example of adjustments used in the calculation method.

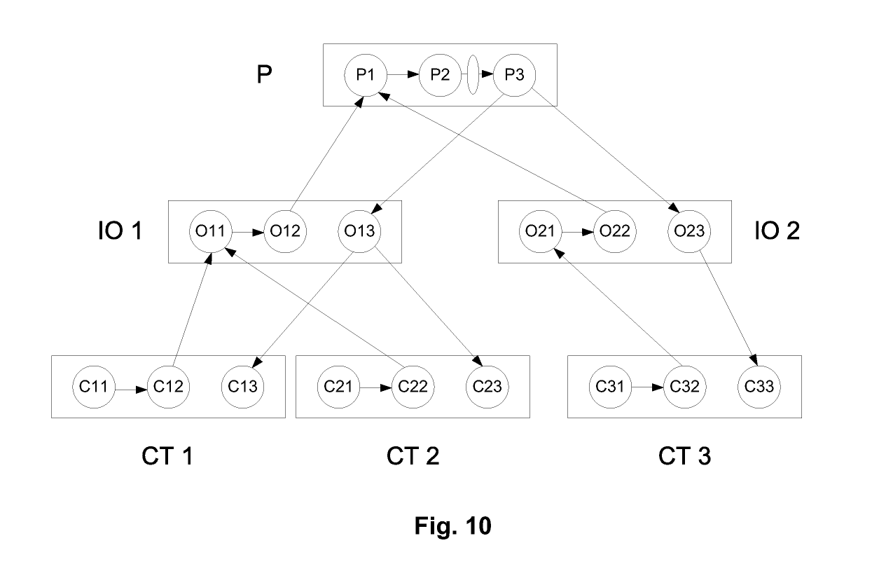

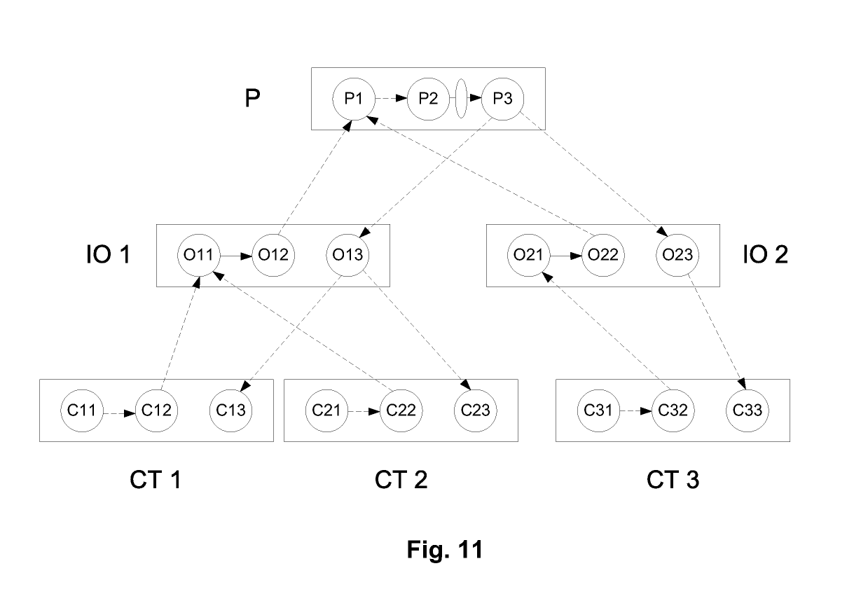

FIG. 10 shows another example of the calculation method in which a final validation step is performed after obtaining the adjusted value of a premium but before the rebalancing step, in order to validate whether the final adjusted value satisfies any pre-determined validation criteria. Although only one final validation step is shown in the figure, a person skilled in the art will appreciate that the number of the final validation step can be more than one, and only when all the steps are satisfied, the method can continue. As shown in FIG. 11, in one embodiment, if one of the final validation steps is failed, all previous calculation results are evicted and calculation is retried by for example resetting adjustment factors. In one embodiment, when a max retry time limit is reached, for example, 10 times or less, the method is ended and an error is reported.

In one embodiment of the calculation method, the type and sequence of adjustment is determined, followed by one or more adjustments of the initial values as obtained by predetermined functions, and the one or more adjustments are applied according to the type and sequence previously determined. As described above, the term “determining” is a process of selection or allocation. For example, one or more types of adjustment can be selected for use from a list of types of adjustment currently available. Alternatively, a new type of adjustment may be added. Further examples include one or more types of adjustment or factors thereof may be modified, and one or more types of adjustment can be deleted from the list currently available. The process of “determining” also includes a step of allocating each of the types of adjustment to a suitable subject to be adjusted. For example, one or more types of adjustment may be allocated to insurance coverage, or one or more types of adjustment, same with or different than those allocated to insurance coverage, may be allocated to insured object, and/or one or more types of adjustment, same with or different than those described above, may be allocated to insurance policy, such that the types of adjustments determined are applied at levels of insurance coverage, insured object and/or insurance policy. Available types of adjustments may include, but not limited to, minimum premium, period of insurance (P01), discounts, loading, underwriting, campaign, tax, fee, commission, and assignment.

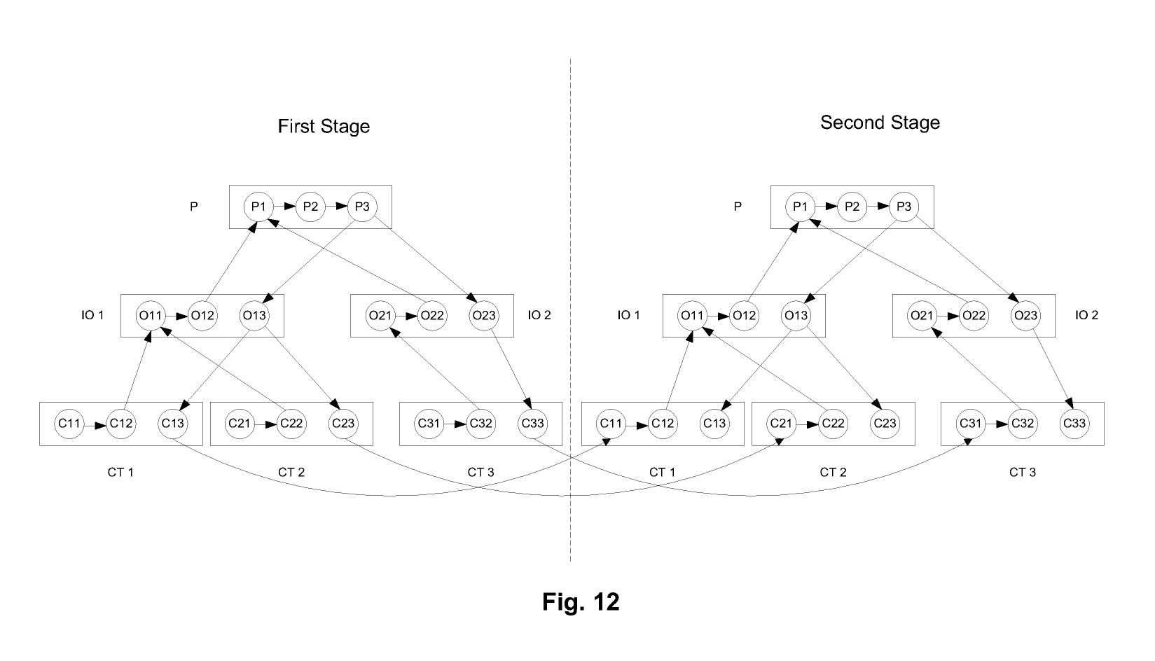

FIG. 12 shows a method of insurance related fees calculation for an insurance product, according to another embodiment of the invention. In this embodiment, the insurance product contains two insured objects, IO1 and IO2. The insured object IO1 contains insurance coverage CT1 and CT2, and the insured object IO2 contains coverage CT3.

The method is performed in two or more stages. In the first stage, the method performs as shown in FIG. 7 to obtain rebalanced values C13, C23 and C33 for coverage. In the second stage, the rebalanced values C13, C23 and C33 are served as initial values C11, C21 and C31 for coverage and steps similar to those in the first stage are carried out to obtain another rebalanced values for coverage in the second stage. The another rebalanced values may be further served as initial values for coverage in a next stage. In each stage, one or more adjustments, of different types from stage to stage, are applied until all the types of adjustment as previously determined are applied. The adjusted values obtained after the last adjustment are served as insurance related fees for the insurance product. For example, the adjusted value of premium after last adjustment is served as a premium of policy for the insurance product.

As described above, during rebalancing step, in the first stage, the adjusted value of premium is rebalanced on the basis of contribution ratio of the adjusted values of insured objects at the first stage to the initial value of the insurance product. In the second or any further stage, the adjusted value of premium is rebalanced on the basis of contribution ratio of the adjusted values of insured objects at respective stage to the initial value of the insurance product, or of contribution ratio of the adjusted values of insured objects at the first stage to the initial value of the insurance product.

Similarly, as stated above, in the first stage, the rebalanced value of an insured object is further rebalanced on the basis of contribution ratio of the adjusted values of insurance coverage at the first stage to the initial value of corresponding insured object. In the second or any further stage, the rebalanced value of an insured object is rebalanced on the basis of contribution ratio of the adjusted values of insurance coverage at respective stage to the initial value of corresponding insured object, or of contribution ratio of the adjusted values of insurance coverage at the first stage to the initial value of corresponding insured object.

In some embodiments, the rebalanced values are obtained by rounding-off. In some embodiments, the rebalanced values for the last insured object and the last insurance coverage are obtained by rounding up.

In one embodiment of the calculation method, the type and sequence of adjustment is determined, followed by one or more adjustments of the initial values as obtained by predetermined functions, and the one or more adjustments are applied according to the type and sequence previously determined. As described above, the term “determining” is a process of selection or assignment. For example, one or more types of adjustment can be selected for use from a list of types of adjustment currently available. Alternatively, a new type of adjustment may be added. Further examples include one or more types of adjustment or factors thereof may be modified, and one or more types of adjustment can be deleted from the list currently available. The process of “determining” also includes a step of allocating each of the types of adjustment to a suitable subject to be adjusted. For example, one or more types of adjustment may be allocated to insurance coverage, or one or more types of adjustment, same with or different than those allocated to insurance coverage, may be allocated to insured object, and/or one or more types of adjustment, same with or different than those described above, may be allocated to insurance policy, such that the types of adjustments determined are applied at levels of insurance coverage, insured object and/or insurance policy. Available types of adjustments may include, but not limited to, minimum premium, period of insurance (P01), discounts, loading, underwriting, campaign, tax, fee, commission, and assignment.

In some embodiments, a final validation step is performed after obtaining the adjusted value of a premium but before the rebalancing step, in order to validate whether the final adjusted value satisfies any pre-determined validation criteria. The number of the final validation step can be one or more, and only when all the steps are satisfied, the method can continue. In one embodiment, if one of the final validation steps is failed, all previous calculation results are evicted and calculation is retried for example by resetting adjustment factors. In one embodiment, when a max retry time limit is reached, for example, 10 times or less, the method is ended and an error is reported.

It should be understood that the examples described herein are provided for illustrative purpose only. Various changes, modifications, and substitutions may be made to the invention within the spirit of the invention, which are all included within the scope of the invention as defined in the claims.

1. A computer-implemented method for adjustment in calculation of insurance related fees for an insurance product, the method comprising steps of
(a) determining type and sequence of adjustments;
(b) applying one or more adjustments to an initial value obtained by a predetermined function, according to the type and sequence of adjustments as determined in step (a); and
(c) serving an adjusted value so obtained in step (b) as basis for subsequent calculation.

2. The computer-implemented method of claim 1, wherein the type of adjustment is selected from a group consisting of minimum premium, period of insurance, discount, loading, underwriting, campaign, tax, fee, commission, assignment and null.

3. The computer-implemented method of claim 1, wherein each of the type of adjustment contains one or more adjustment factors.

4. The computer-implemented method of claim 3, wherein the one or more adjustment factors is selected from a group consisting of fixed amount, percentage, maximum value and minimum value.

5. The computer-implemented method of claim 4, wherein the fixed amount or the percentage contains, respectively, a plurality of different fixed values, or a plurality of different percentages.

6. The computer-implemented method of claim 1, wherein an adjusted value following an adjustment is larger than an initial value before the adjustment.

7. The computer-implemented method of claim 1, wherein an adjusted value following an adjustment is less than an initial value before the adjustment.

8. The computer-implemented method of claim 1, wherein an adjusted value following an adjustment is equal to an initial value before the adjustment.

9. The computer-implemented method of claim 1, wherein one or more pre-apply criteria is applied immediately before one or more adjustments is applied.

10. The computer-implemented method of claim 1, wherein one or more post-apply criteria is applied immediately after one or more adjustments is applied.

11. The computer-implemented method of claim 1, wherein one or more final validation step is performed after the last adjustment.

12. The computer-implemented method of claim 11, wherein if one of the final validation steps is failed, all previous calculation results are evicted and calculation is retried by resetting an adjustment factor.

13. The computer-implemented method of claim 12, wherein when a max retry time limit is reached, the method is ended and an error is reported.

14. The computer-implemented method of claim 1, wherein the sequence is determined according to any of the type of adjustment, adjustment factor and adjustment priority.

15. The computer-implemented method of claim 1, wherein the insurance related fees are premium for policy, or insurance derivative fees originated from the premium for policy.

16. A system for adjustment in calculation of insurance related fees for an insurance product, the system comprising
a storage device, for storing pre-determined functions and adjustment functions; and
at least one processor, configured to perform a method comprising steps of
(a) determining type and sequence of adjustments;
(b) applying one or more adjustments to an initial value obtained by a predetermined function, according to the type and sequence of adjustments as determined in step (a); and
(c) serving an adjusted value so obtained in step (b) as basis for subsequent calculation.

17. The system of claim 16, wherein the type of adjustment is selected from a group consisting of minimum premium, period of insurance, discount, loading, underwriting, campaign, tax, fee, commission, assignment and null.

18. The system of claim 16, wherein each of the type of adjustment contains one or more adjustment factors.

19. The system of claim 18, wherein the one or more adjustment factors is selected from a group consisting of fixed amount, percentage, maximum value and minimum value.

20. The system of claim 19, wherein the fixed amount or the percentage contains, respectively, a plurality of different fixed values, or a plurality of different percentages.

21. The system of claim 16, wherein the at least one processor is further configured to apply one or more pre-apply criteria immediately before one or more adjustments is applied.

22. The method of claim 16, wherein the at least one processor is further configured to apply one or more post-apply criteria immediately after one or more adjustments is applied.

23. The system of claim 16, wherein the at least one processor is further configured to perform one or more final validation steps after the last adjustment.

24. The system of claim 23, wherein if one of the final validation steps is failed, all previous calculation results are evicted and calculation is retried by resetting an adjustment factor.

25. The system of claim 24, wherein when a max retry time limit is reached, the final validation is ended and an error is reported.

26. The system of claim 16, wherein the sequence is determined according to any of the type of adjustment, adjustment factor and adjustment priority.

27. The system of claim 16, wherein the insurance related fees are premium for policy, or insurance derivative fees originated from the premium for policy.
